(19) United States
(12) Patent Application Publication
(10) Pub. No.: US 2017/0108204 A1
(43) Pub. Date: Apr. 20, 2017

(54) LED LIGHT BULB USING LAMP CAP FOR HEAT DISSIPATION

(71) Applicant: UNITY OPTO TECHNOLOGY CO., LTD., NEW TAIPEI CITY (TW)

(72) Inventors: CHIH-HSIEN WU, NEW TAIPEI CITY (TW); KAI-CHENG CHUANG, NEW TAIPEI CITY (TW); SEN-YUH TSAI, NEW TAIPEI CITY (TW)

(21) Appl. No.: 14/990,985

(22) Filed: Jan. 8, 2016

(30) Foreign Application Priority Data
Oct. 16, 2015 (TW) 104134008

(51) Int. Cl. F21V 29/70; F21K 9/232; F21V 23/06; F21K 9/235

(52) U.S. Cl. CPC F21V 29/70; F21K 9/235; F21K 9/232; F21V 23/06; F21Y 2115/10

(57) ABSTRACT

An LED light bulb using a lamp cap for heat dissipation includes abuse a first substrate for carrying LEDs, a cooling carrier seat installed in the base and having a carrying portion and at least one supporting rib, and the supporting rib has an end fixed to the carrying portion and the other end fixed to the cooling carrier seat.

### CROSS-REFERENCE TO RELATED APPLICATIONS

This non-provisional application claims priority under 35 U.S.C. §119(a) on Patent Application No(s). 104134008 filed in Taiwan, R.O.C. on Oct. 16, 2015, the entire contents of which are hereby incorporated by reference.

### TECHNICAL FIELD

The technical field relates to LED light bulbs, and more particularly to the LED light bulb using a lamp cap to dissipate heat and capable of dispersing and conducting heat to outside with an excellent heat dissipation efficiency.

### BACKGROUND

In recent years, bulb lamps are evolved from incandescent lamps of early stage to present light emitting diode (LED) lamps which are used as a light source. Due to the advantages of high color rendering and light emitting efficiency, the LED becomes a popular light source for the bulb lamps.

Although LED has the aforementioned advantages, its application still has a serious heat dissipation issue. When the LED is electrically conducted, energy in form of visible light is consumed, and the remaining energy is converted into heat energy, and the heat cannot be dissipated to the outside by radiation or convection effectively due to the limited volume and the small packaging area of the chip. As a result, the heat is accumulated in LED light bulb. In addition, related control components for controlling and driving the light emission of the LED are installed in the LED light bulb and electrically coupled to a circuit board that carries the LED. Similarly, the control components also generate heat during the illumination of the LED light bulb, and most LEDs and control components are installed on the circuit board, so that a portion of the circuit board becomes a portion having most accumulated heat of the LED light bulb. After a long time of use, the operation of the electronic circuit may be affected or the material may be cracked by thermal expansion if the aforementioned heat cannot be dissipated successfully. Particularly, the heat dissipation of a forward LED light bulb is relatively more difficult due to the way of installing the LED and electronic components. Therefore, it is an important subject for related designers or manufacturers to dissipate the heat of the LED light bulb effectively.

To conduct heat, some manufacturers add fins to the LED light bulb to conduct the heat to the outside through the gaps between the fins and the convection of air, so as to achieve the heat dissipating effect. However, several factors must be taken into consideration for the installation of the fins, since it is necessary re-design the fins when the type and installation position of any of the LEDs and electronic components for controlling the LED light bulb is changed, and thus increasing the overall design and production costs. In addition, the fins play the role of conducting heat from the LED light bulb to the outside, and LEDs and control components are installed in a portion of the circuit board, and such portion becomes an area with most accumulated heat. When the LED light bulb is operated continuously, the fins are unable to dissipate all heat to the outside by using their limited heat conducting areas, so that a large quantity of heat still exists in the LED light bulb. If the fin heat conducting area is increased to overcome this problem, the volume of the LED light bulb will be increased accordingly, and a large LED light bulb fails to comply with market requirements.

Since the application of fins for heat dissipation has the aforementioned drawbacks, therefore an LED bulb using a lamp cap for heat dissipation in accordance with R.O.C. Utility Model No. M501530 is disclosed, and the LED bulb comprises a lamp cap, a lamp cover, a driving power supply installed in the lamp cap, an upper circuit board casing installed in the lamp cover, one or more of LED lamp panels of a lower circuit board casing installed in the lamp cap, and a thermal conductive adhesive disposed between the interior of the lamp cap and the LED lamp panel. With the aforementioned design, heat will be concentrated at the lamp cap during the operation of the LED lamp panel and the driving power supply and conducted to the lamp cap through the thermal conductive adhesive, and finally the heat energy is conducted to the lamp to achieve the heat dissipation effect. However, the thermal conductive adhesive of the LED light bulb cannot be filled between the lamp cap and the LED lamp panel after the LED lamp panel is soldered between upper and lower circuit board casings and installed in the lamp cap and the lamp cover, so that it is necessary to coat the thermal conductive adhesive onto an area of the lamp cap in contact with the LED lamp panel or onto the LED lamp panel, and then an end of the LED lamp panel is attached and fixed into the lamp cap, so that the thermal conductive adhesive is attached between the lamp cap and the LED lamp panel, and such adhesion is weak and the LED lamp panel cannot be fixed tightly to the lamp cap. In addition, the heat generated by the LED bulb of this structure is conducted to and concentrated at the lamp cap, and only a portion of the lamp cap conducts the heat through the contact of the thermal conductive adhesive with the LED lamp panel. In addition to the weak adhesiveness, the heat conducting area is too small, so that the heat conductivity is low, and the heat dissipation efficiency is poor, and the area of the lamp cap is usually overheated during the operation of the LED bulb since the heat is concentrated at the lamp cap. Obviously, such LED light bulb fails to comply with the safety specification or even jeopardize public or user safety.

In view of the aforementioned problems of the conventional LED light bulbs, the discloser of this disclosure developed an LED light bulb to overcome the problems of the prior art.

### SUMMARY

It is a primary objective of this disclosure to provide an LED light bulb using a lamp cap for heat dissipation, wherein the LED and the driving circuit are installed separately, so that the heat can be dispersed to avoid its being accumulated at a place during the operation of the LED light bulb, and a structural design for the heat dissipation is provided for the LED and the driving circuit separately, so that the light bulb has an excellent heat dissipation efficiency and a long service life.

To achieve the aforementioned and other objectives, this disclosure provides an LED light bulb using a lamp cap for heat dissipation, and the LED light bulb comprises: a base, which is hollow; a first substrate, for carrying a plurality of LEDs; a cooling carrier seat, installed in the base, and having a carrying portion and at least one supporting rib disposed on a side of the cooling carrier seat, and the carrying portion being provided for installing the first substrate, and the supporting rib having an end fixed to the carrying portion and the other end fixed to an inner side of the cooling carrier seat; at least one second substrate, installed in the cooling carrier seat, and the first substrate and the second substrate being perpendicularly and respectively installed on both sides of the carrying portion, and the second substrate being provided for carrying a driving circuit, and the driving circuit being electrically coupled to the LEDs; a lamp cap, installed and coupled to a side of the base; a thermal glue, filled between the driving circuit and the lamp cap, and a first conducting area and a second conducting area being formed and configured to be corresponsive to the driving circuit and the lamp cap respectively, wherein the first conducting area is attached onto the driving circuit, and the second conducting area is attached onto the lamp cap; and a lamp cover, covered onto the base to seal the first substrate and the LEDs therein. Therefore, the LED light bulb has the LEDs and the driving circuit separated from each other by the first substrate and the second substrate to achieve the effect of dividing the heat existing areas. In the meantime, the LEDs are collocated with the cooling carrier seat, and the driving circuit is collocated with the thermal glue and the lamp cap for conducting the heat generated during the operation to the outside, so as to achieve a high heat dissipation efficiency of the LED light bulb.

Wherein, the second substrate may come with a plural quantity. For two second substrates, they are installed opposite to each other. For three second substrates, the angle formed between two adjacent second substrates is equal to 60 degrees. For n second substrates and n≧4, the included angle between any two adjacent second substrates is equal to

$$\frac{360}{n}$$

degrees, so that the heat generated by the driving circuit of each second substrate is dispersed and conducted uniformly to different areas of the lamp cap through the thermal glue, so as to prevent a certain area of the lamp cap from receiving too much heat or causing a non-uniform heat dissipation.

In addition, the LED light bulb using a lamp cap for heat dissipation further comprises at least one electrical connector installed on the first substrate, and the carrying portion has at least one opening corresponsive to the electrical connector, and a side of the electrical connector has a slot for mounting the second substrate and electrically coupling the driving circuit with the LEDs, so that the first substrate and the second substrate may be installed or removed quickly through the electrical connector.

In another implementation mode based on this preferred embodiment, the supporting rib divides the interior of the cooling carrier seat into at least one filling hole for filling the thermal glue, so that after components are installed, the thermal glue can be filled between the driving circuit and the lamp cap quickly and directly through the filling hole, so as to assemble and manufacture the LED light bulb quickly.

In another preferred embodiment of this disclosure, an LED light bulb using a lamp cap for heat dissipation comprises: a base, being hollow, and having a connecting portion, and the connecting portion having at least one notch; a first substrate, for carrying a plurality of LEDs; a cooling carrier seat, and having a carrying portion and at least one supporting rib disposed on a side of the cooling carrier seat, and the carrying portion being provided for installing the first substrate, and the supporting rib having an end fixed to the carrying portion and the other end fixed to an inner side of the cooling carrier seat; installed in the cooling carrier seat, and the first substrate and the second substrate being perpendicular to each other and installed on both opposite sides of the carrying port on, and the second substrate being provided for carrying a driving circuit, and the driving circuit being electrically coupled to the LEDs and configured to be corresponsive to the notch to define an exposed status; a lamp cap, coupled to the connecting portion; a thermal glue, filled between the driving circuit and the lamp cap, and having a first conducting area and a second conducting area corresponsive to the driving circuit and the lamp cap respectively, wherein the first conducting area is attached to the driving circuit, and the second conducting area is attached to the lamp cap; and a lamp cover, covered onto the base for sealing the first substrate and the LEDs therein.

Similarly, the second substrate may come with a plural quantity. For two second substrates, they are installed opposite to each other. For three second substrates, the included angle between two adjacent second substrates is equal to 60 degrees. For n second substrates and n≧4, the included angle between any two adjacent second substrates is equal to

$$\frac{360}{n}$$

degrees, so that the heat generated by the driving circuit of each second substrate is dispersed and conducted uniformly to different areas of the lamp cap through the thermal glue, so as to prevent a certain area of the lamp cap from receiving too much heat or causing a non-uniform heat dissipation.

In addition, the base and the lamp cap are assembled by a rotational connection method, so that the thermal glue is coated onto the connecting portion to increase the heat conducting area, so as to increase the heat dissipating area of the lamp cap to achieve a better heat dissipation efficiency.

In addition, the LED light bulb using a lamp cap for heat dissipation further comprises at least one electrical connector installed on the first substrate, and the carrying portion has at least one opening corresponsive to the electrical connector, and a side of the electrical connector a side has a slot for mounting the second substrate and electrically coupling the driving circuit with the LEDs, so that the first substrate and the second substrate may be installed or removed quickly through the electrical connector.

In summation of the description above, the LED light bulb using the lamp cap for heat dissipation in accordance with this disclosure has the LEDs and the driving circuit installed on the first substrate and the second substrate respectively to disperse the heat, and the LEDs are installed on the first substrate, so that the heat can be conducted to the outside through the cooling carrier seat effectively, and the driving circuit is installed on the second substrate and the thermal glue is used as a medium of thermal conduction, so that the heat generated during the operation of the LED light bulb can be transmitted to the lamp cap and dissipated to the outside, so as to prevent the heat from concentrating at a specific area or causing a poor heat dissipation efficiency, or even accumulating too much heat to result in a too-high temperature exceeding to the temperature as specified in the safety regulation. In addition, the thermal glue may be applied in various different ways and filled between the driving circuit and the lamp cap to increase the volume or area of the thermal glue serving as a heat conducting medium and achieve a better heat dissipation efficiency. In addition, the installation of the electrical connector provides a simple, easy and quick assembling process of the first substrate and the second substrate and facilitates repair and maintenance. Therefore, the LED light bulb using a lamp cap for heat dissipation in accordance with this disclosure is capable of dissipating heat during the operation of electronic components and corresponsive to the heat dissipation design with an excellent heat dissipation efficiency, and such LED light bulb also can extend the overall service life.

### BRIEF DESCRIPTION OF THE DRAWINGS

FIG. 1 is an exploded view of a first preferred embodiment of this disclosure;

FIG. 2 is a perspective view of the first preferred embodiment of this disclosure;

FIG. 3 is a cross-sectional view of the first preferred embodiment of this disclosure;

FIG. 4 is a schematic view of another implementation mode of a cooling carrier seat in accordance with the first preferred embodiment of this disclosure;

FIG. 5 is a cross-sectional view of another implementation mode of the first preferred embodiment of this disclosure;

FIG. 6 is a perspective view of a second preferred embodiment of this disclosure;

FIG. 7 is a schematic planar view of the second preferred embodiment of this disclosure; and

FIG. 8 is a schematic planar view of another implementation mode of the second preferred embodiment of this disclosure.

### DESCRIPTION OF THE PREFERRED EMBODIMENTS

The above and other objects, features and advantages of this disclosure will become apparent from the following detailed description taken with the accompanying drawings.

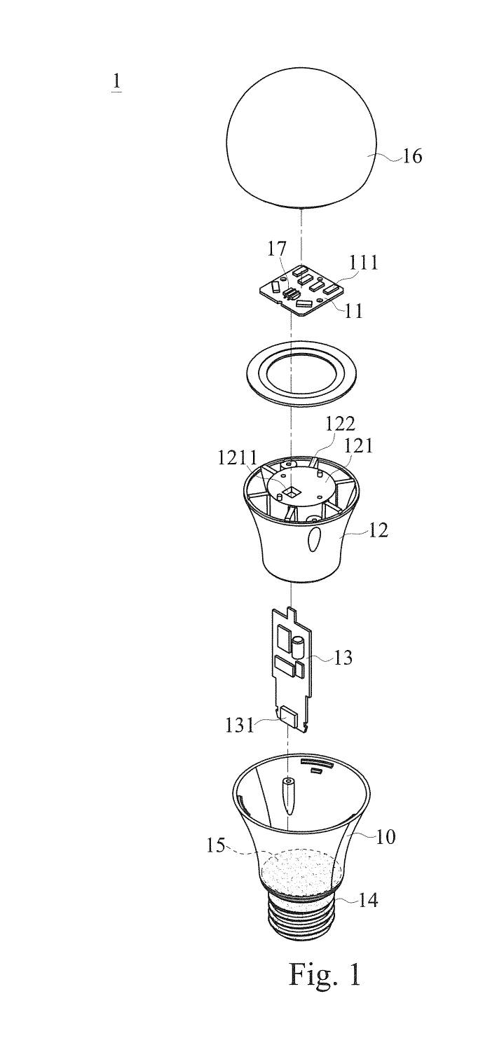

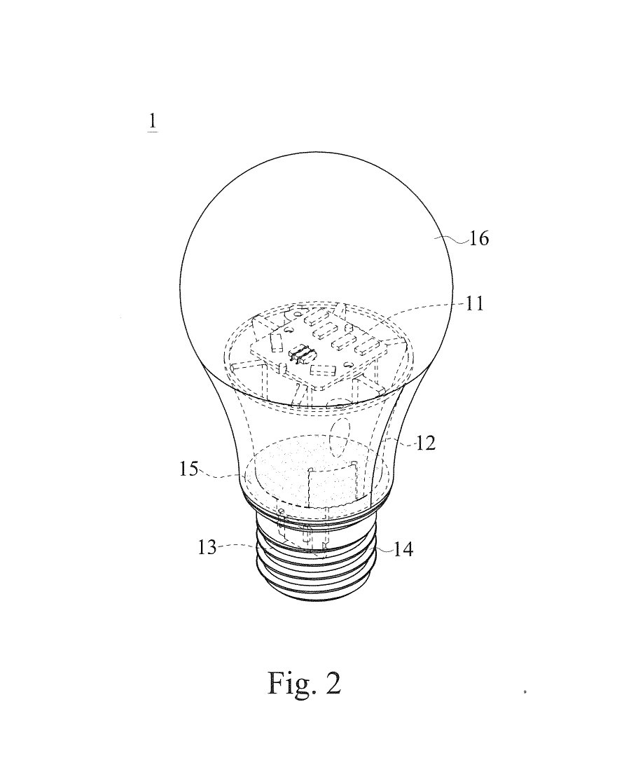

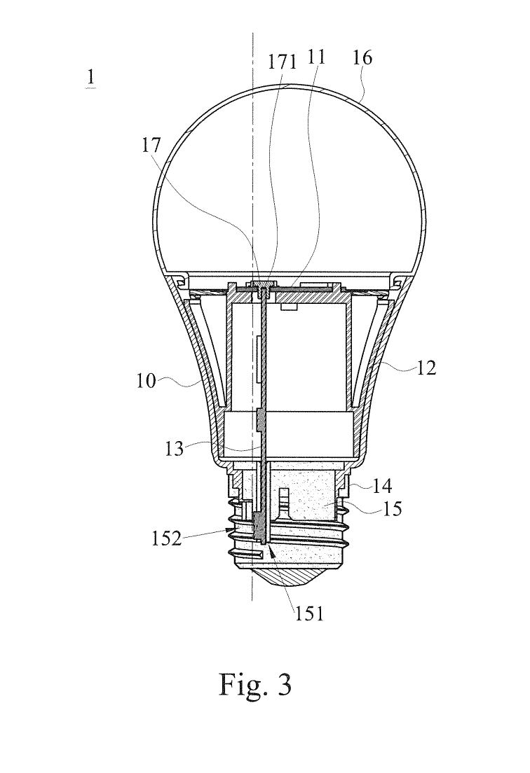

With reference to FIGS. 1, 2 and 3 for an exploded view, a perspective view and a cross-sectional view of an LED light bulb using a lamp cap for heat dissipation in accordance with a first preferred embodiment of this disclosure respectively, the LED light bulb using a lamp cap for heat dissipation 1 comprises a base 10, a first substrate 11, a cooling carrier seat 12, at least one second substrate 13, a lamp cap 14, a thermal glue 15 and a lamp cover 16.

The base 10 is hollow and provided for accommodating the cooling carrier seat 12, the base 10 has a side coupled to the lamp cap 14 and the other side coupled to the lamp cover 16. The first substrate 11 is provided for carrying a plurality of LEDs 111.

The cooling carrier seat 12 is disposed in the base 10 and includes a carrying portion 121 and at least one supporting rib 122 disposed on a side of the cooling carrier seat 12, and a side of the cooling carrier seat 12 having the carrying portion 121 and the supporting rib 122 is hollow. The carrying portion 121 is provided for installing the first substrate 11, and the supporting rib 122 has an end fixed to the carrying portion 121 and the other end fixed to an inner side of the cooling carrier seat 12 for fixing the carrying portion 121, wherein there is a plurality of supporting ribs 122 in this preferred embodiment. Preferably, the cooling carrier seat 12 is made of metal or plastic with a heat dissipating effect. After the LEDs 111 installed on the first substrate 11 are driven, the generated heat is conducted to the outside through the cooling carrier seat 12 to prevent the heat from being accumulated and concentrated at the first substrate 11 and affecting the use of the LEDs 111 or even damaging the LEDs 111.

The second substrate 13 is installed in the cooling carrier seat 12, and the first substrate 11 and the second substrate 13 are perpendicular to each other and installed on both sides of the carrying portion 121, and the second substrate 13 is provided for carrying a driving circuit 131, and the driving circuit 131 is electrically coupled to the LEDs 111. Wherein, the driving circuit 131 includes electronic components such as an integrated chip (IC), a metal oxide semiconductor field effect transistor (MOSFET) for controlling the light emitting status of the LEDs 111.

The lamp cap 14 is installed and coupled to a side of the base 10 for installing the LED light bulb 1 to a lamp. The thermal glue 15 is filled between the driving circuit 131 and the lamp cap 14, and a first conducting area 151 and a second conducting area 152 are formed corresponsive to the driving circuit 131 and the lamp cap 14 respectively, wherein the first conducting area 151 is attached to the driving circuit 131, and the second conducting area 152 is attached to the lamp cap 14, so that the thermal glue 15 may act as a heat conducting medium of the driving circuit 131 and the lamp cap 14, and the heat generated during the operation of the driving circuit 131 may be transmitted from the first conducting area 151 to the second conducting area 152 by using the thermal glue 15 as a medium and then the heat is dissipated to the outside through the lamp cap 14, so as to prevent the heat from being accumulated to affect the use of the driving circuit 131 or cause damages. The lamp cover 16 is covered onto the base 10 for sealing the first substrate 11 and the LEDs 111 therein, so as to form the LED light bulb 1.

Therefore, the LED light bulb 1 of this disclosure can overcome the heat dissipation problem during the operation of the LEDs 111 and the driving circuit 131. The LED light bulb 1 uses the cooling carrier seat 12 to separate the first substrate 11 provided for installing the LEDs 111 and the second substrate 13 provided for installing the driving circuit 131 and guides the heat of the LEDs 111 to the outside by the cooling carrier seat 12, and the heat of the driving circuit 131 is transmitted through the thermal glue 15 to the lamp cap 14 and then dissipated to the outside. Therefore, heat of the LEDs 111 and the driving circuit 131 will not be concentrated at a specific area to prevent the occurrence of overheat at any particular portion of the bulb.

Wherein, the thermal glue 15 may be filled from the base 10 after the base 10 and the lamp cap 14 are coupled and installed, and then the remaining components are installed one by one, so that the thermal glue 15 forms the first conducting area 151 corresponsive to the driving circuit 131 and the second conducting area 152 corresponsive to the lamp cap 14. The position for applying the thermal glue 15 inside the cooling carrier seat may be adjusted to fit the second substrate 13 and assure that the first conducting area 151 and the second conducting area 152 are attached on the driving circuit 131 and the lamp cap 14 respectively. For example, if the length of the second substrate 13 is relatively short, such that the second substrate 13 is not extended into the lamp cap 14 after the second substrate 13 is installed to the cooling carrier seat 12, then the thermal glue 15 will be filled up into the lamp cap 14 and partially filled in the cooling carrier seat 12. If the length of the second substrate 13 is relatively long, such that the second substrate 13 is extended into the lamp cap 14 after the second substrate 13 is installed to the cooling carrier seat 12, then it simply needs to fill the thermal glue 15 into a portion of the lamp cap 14 in order to form the first conducting area 151 and the second conducting area 152. However, the way of filling the thermal glue 15 is not limited to the aforementioned arrangement only, but it can be modified or changed according to various installation modes of the second substrate 13. Since the thermal glue 15 is filled between the driving circuit 131 and the lamp cap 14, therefore the thermal glue 15 acts as a medium of transferring heat to increase the heat conducting area and improve the heat dissipating effect.

In addition, the LED light bulb 1 further comprises at least one electrical connector 17 installed on the first substrate 11, a slot 171 formed on a side of the electric connector 17 and provided for mounting the second substrate 13, so that the driving circuit 131 is electrically coupled to the LEDs 111, and the carrying portion 121 has at least one opening 1211 corresponsive to the electrical connector 17. After the first substrate 11 is installed to the carrying portion 121, the second substrate 13 is coupled to the slot 171 of the electrical connector 17 through the opening 1211, and the electrical connector 17 is provided for assuring the LEDs 111 to be in contact with the driving circuit 131 and simplifying the required wiring process, so as to make the assembling process of the LED light bulb 1 quicker and more conveniently and provides convenient repair and maintenance.

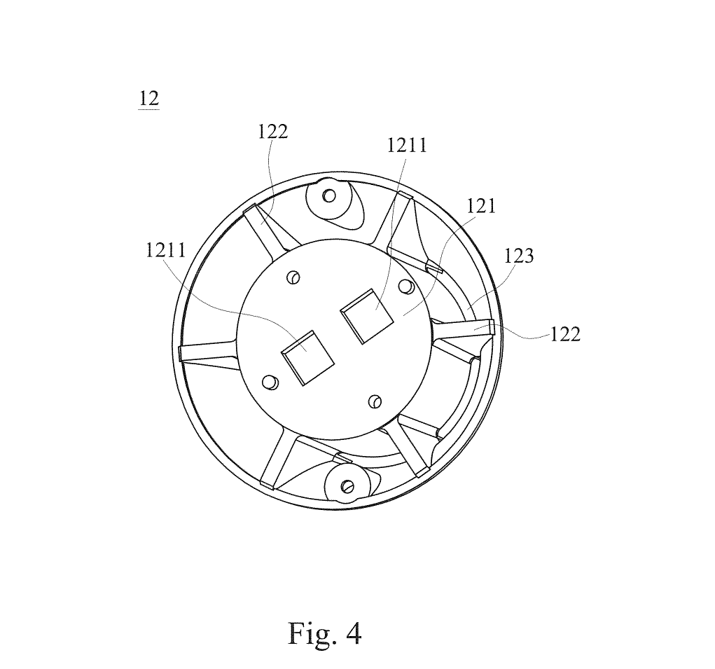

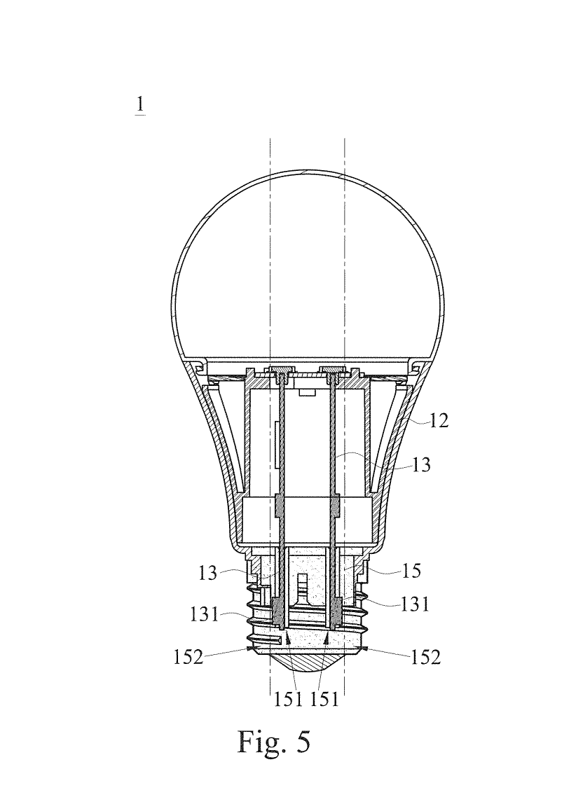

With reference to FIGS. 4 and 5 for a schematic view and a cross-sectional view of a cooling carrier seat in accordance with another implementation mode of the first preferred embodiment of this disclosure respectively, there are plural second substrates 13. For two second substrates 13, the second substrates are installed opposite to each other. For three second substrates, the second substrates 13 are arranged with an included angle equal to 60 degrees between any two adjacent second substrates 13. For n second substrates 13 and n≧4, the second substrates 13

$$\frac{360}{n}$$

are arranged with an included angle equal to degrees between any two adjacent second substrates 13. In this implementation mode, there are two second substrates 13, and the quantity and position of the openings 1211 of the carrying portion 121 and the electrical connectors 17 are corresponsive to those of the second substrate 13. When the two second substrates 13 are installed opposite to each other, the heat of the driving circuit 131 of each second substrate 13 may be dissipated uniformly to the lamp cap 14 through the thermal glue 15 to facilitate the heat dissipation. For example, when the two opposite second substrates 13 are operated, approximately one half of the area of the driving circuit 131 is allocated to the lamp cap 14 for transferring heat, so that the heat transfer areas can be scattered effectively to prevent the heat from being concentrated or affecting the heat dissipation efficiency. If the quantity of the second substrates 13 is greater than two, and the included angle between two adjacent second substrates 134 is limited to the aforementioned angle, the heat conducting areas can be scattered for dissipating heat uniformly. The supporting rib 122 divides the interior of the cooling carrier seat 12 into at least one filling hole 123. In this implementation mode, there are plural supporting ribs 122, so that the supporting ribs 122 separates the cooling carrier seat 12 to form the plurality of filling holes 123 provided for filling the thermal glue 15. In other words, after the first substrate 11 and the second substrates 13 are installed, and the cooling carrier seat 12 and the lamp cap 14 are installed in the base 10 and coupled to a side of the base 10, the thermal glue 15 may be filled into the cooling carrier seat 12 and the lamp cap 14 through the filling holes 123, so as to provide a quick and convenient way of filling the thermal glue 15, and assure that the thermal glue 15 forms the first conducting area 151 corresponsive to the driving circuit 131 and the second conducting area 152 corresponsive to the lamp cap 14.

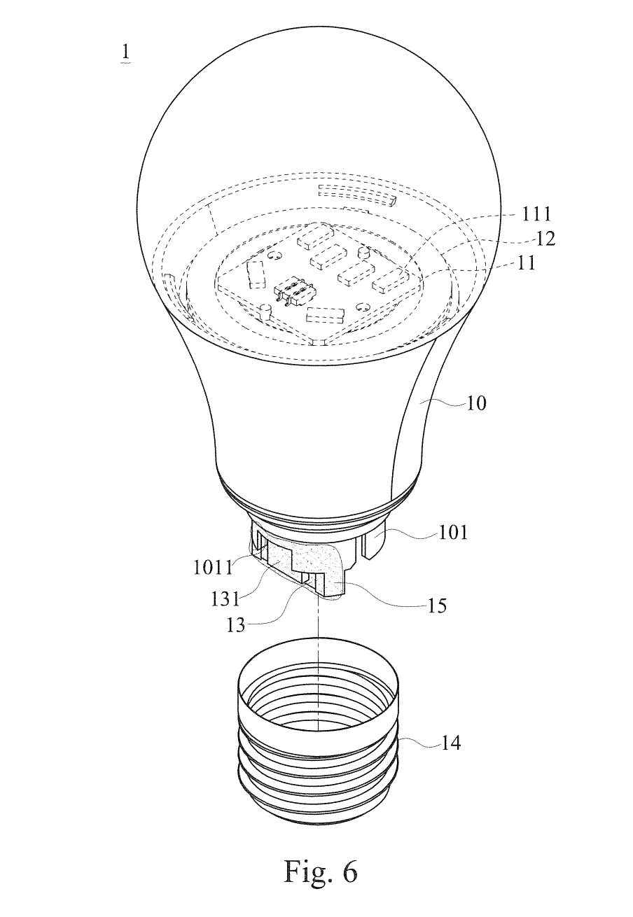

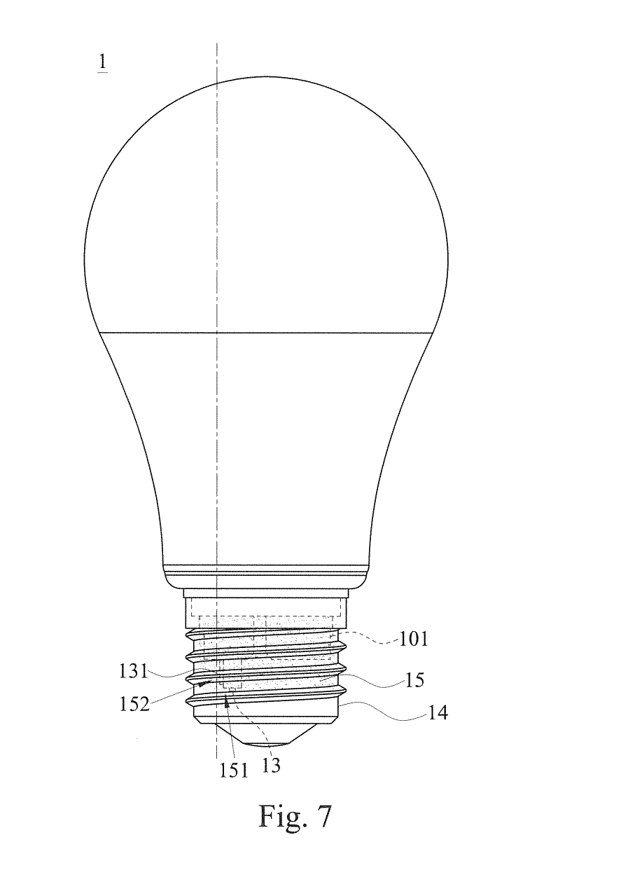

With reference to FIGS. 6 and 7 [bra perspective view and a schematic planar view of a second preferred embodiment of this disclosure, the technical characteristics of this preferred embodiment same as those of the first preferred embodiment will not be repeated, and only the differences are described below. In the LED light bulb 1 using a lamp cap for heat dissipation, the base 10 has a connecting portion 101 for connecting and installing the lamp cap 14, and the connecting portion 101 has at least one notch 1011, and the driving circuit 131 of the second substrate 13 installed in the cooling carrier seat 12 is configured to be corresponsive to the notch 1011 and exposed to the outside. The thermal glue 15 is also filled between the driving circuit 131 and the lamp cap 14 to form the first conducting area 151 and the second conducting area 152 corresponsive to the driving circuit 131 and the lamp cap 14 respectively to transfer the heat generated during the operation of the driving circuit 131 to the lamp cap 14, so as to achieve the heat dissipating effect. With the cooling carrier seat 12, the heat source of the LED light bulb 1 is separated to prevent the heat from concentrating in a specific area to achieve a better heat dissipating effect. Since the base 10 and the lamp cap 14 are assembled by a rotational connection method, therefore the thermal glue 15 is coated onto the connecting portion 101 when the base 10 and the lamp cap 14 are rotated and installed, on as to increase the area of the thermal glue 15 for transferring heat and obtain a better heat dissipating efficiency.

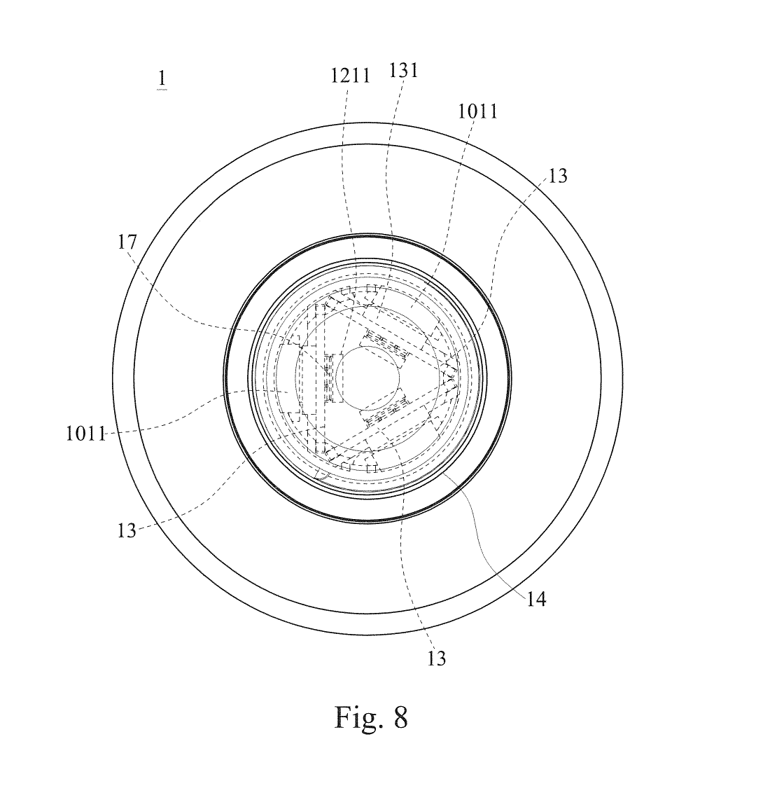

With reference to FIG. 8 for a schematic planar view of another implementation mode of the second preferred embodiment of this disclosure, this preferred embodiment is substantially the same as the first preferred embodiment, and the quantity of the second substrates 13 is plural. For two second substrates 13, the two second substrates 13 are installed opposite to each other. For three second substrates 13, the second substrates 13 are arranged with an included angle equal to 60 degrees between any two adjacent second substrates 13. If the quantity of the second substrates 13 is n, and n≧4, the second substrates 13 are arranged with an included angle equal to degrees between any two adjacent second substrates 13, and the quantity and position of the notches 1011 are corresponsive to those of the second substrates 13. In this preferred embodiment, there are three second substrates 13, and the included angle between any two adjacent second substrates 13 is approximately equal to 60 degrees. With this arrangement, the heat generated by the driving circuit 131 of each second substrate 13 can be dissipated uniformly, and the heat is transferred to the outside through the first conducting area 151 and the second conducting area 152 of the thermal glue 15. The quantity and position of the electrical connectors 17 and the openings 1211 of the carrying portion 121 are corresponsive to those of the second substrates 13, so that each second substrate 13 is coupled to the first substrate 11 through the electrical connector 17, and each driving circuit 131 is electrically coupled to the LEDs 111.

Since there are plural second substrates 13, and the quantity and position of the notches are corresponsive to those of the second substrates 13, therefore the driving circuit 131 of each second substrate 13 is corresponsive to each respective notch 1011 and exposed to the outside. In the way of filling the thermal glue 15 in accordance with this preferred embodiment, the thermal glue 15 is filled in the notch 1011 after each second substrate 13 is installed to the cooling carrier seat 12. Now, the thermal glue 15 forms the plurality of first conducting areas 151 corresponsive to each driving circuit 131, and the lamp cap 14 is fixed to the connecting portion 101, so that the thermal glue 15 forms the second conducting area 152 corresponsive to the lamp cap 14, and the first conducting areas 121 and the second conducting area 152 are provided for transferring heat of each driving circuit 131 to the lamp cap 14.

In summation of the description above, the LED light bulb 1 using a lamp cap for heat dissipation in accordance with this disclosure mainly comes with the design of separately installing the heat generating components such as the LEDs 111 and the driving circuit 131 in the LED light bulb 1 and providing corresponsive heat dissipations to dispersing the heat while achieving an excellent heat dissipation effect. The LEDs 111 are installed on the first substrate 11, and the heat is transmitted through the cooling carrier seat 12 to the outside effectively, and the driving circuit 131 is installed on the second substrate 13 and the thermal glue 15 is used as a medium of transferring heat, so that the heat generated during the operation of the LED light bulb is transferred to the lamp cap 14 and dissipated to the outside. Wherein, separate substrates are used for carrying different electronic components to prevent the heat generated by the electronic components during the operation of the LED light bulb 1 from concentrating at a specific area or causing a poor heat dissipation efficiency, or even accumulating heat to result in a temperature exceeding the temperature as specified by safety requirements. In addition, the thermal glue 15 may be applied in different ways and filled between the driving circuit 131 and the lamp cap 14 to increase the volume or area of the thermal glue 15 serving as a heat conducting medium and improve the heat dissipation efficiency. With the electrical connector 17, the process of assembling the first substrate 11 and the second substrate 13 becomes simpler, easier and quicker, and the repair and maintenance of the LED light bulb 1 becomes more convenient.

What is claimed is:

1. An LED light bulb using a lamp cap for heat dissipation, comprising:
a base, being hollow;
a first substrate, for carrying a plurality of LEDs;
a cooling carrier seat, installed in the base, and having a carrying portion and at least one supporting rib disposed on a side of the cooling carrier seat, and the carrying portion being provided for installing the first substrate, and the supporting rib having an end fixed to the carrying portion and an another end fixed to an inner side of the cooling carrier seat;
at least one second substrate, installed in the cooling carrier seat, and the first substrate and the second substrate being perpendicular to each other and installed on both opposite sides of the carrying portion, and the second substrate being provided for carrying a driving circuit, and the driving circuit being electrically coupled to the LEDs;
a lamp cap, coupled to a side of the base;
a thermal glue, filled between the driving circuit and the lamp cap, and having a first conducting area and a second conducting area corresponsive to the driving circuit and the lamp cap respectively, wherein the first conducting area is attached to the driving circuit, and the second conducting area is attached to the lamp cap; and
a lamp cover, covered onto the base, for sealing the first substrate and the LEDs therein.

2. The LED light bulb using a lamp cap for heat dissipation according to claim 1, wherein the second substrates are arranged opposite to each other, provided that there are two second substrates.

3. The LED light bulb using a lamp cap for heat dissipation according to claim 1, wherein the second substrates are arranged with an included angle equal to 60 degrees between any two adjacent second substrates, provided that there are three second substrates.

4. The LED light bulb using a lamp cap for heat dissipation according to claim 1, wherein the second substrates are arranged with an included angle equal to 360/n degrees between any two adjacent second substrates, provided that the number of second substrates is n, and n≧4.

5. The LED light bulb using a lamp cap for heat dissipation according to claim 1, further comprising at least one electrical connector, installed on the first substrate, and the carrying portion having at least one opening corresponsive to the electrical connector, and a side of the electrical connector having a slot for mounting the second substrate and electrically coupling the driving circuit with the LEDs.

6. The LED light bulb using a lamp cap for heat dissipation according to claim 1, wherein the supporting rib divides the interior of the cooling carrier seat into at least one filling hole for filling the thermal glue.

7. The LED light bulb using a lamp cap for heat dissipation according to claim 2, wherein the supporting rib divides the interior of the cooling carrier seat into at least one filling hole for filling the thermal glue.

8. The LED light bulb using a lamp cap for heat dissipation according to claim 3, wherein the supporting rib divides the interior of the cooling carrier seat into at least one filling hole for filling the thermal glue.

9. The LED light bulb using a lamp cap for heat dissipation according to claim 4, wherein the supporting rib divides the interior of the cooling carrier seat into at least one filling hole for filling the thermal glue.

10. The LED light bulb using a lamp cap for heat dissipation according to claim 5 wherein the supporting rib divides the interior of the cooling carrier seat into at least one filling hole for filling the thermal glue.

11. An LED light bulb using a lamp cap for heat dissipation, comprising:
a base, being hollow, and having a connecting portion, and the connecting portion having at least one notch;
a first substrate, for carrying a plurality of LEDs;
a cooling carrier seat, and having a carrying portion and at least one supporting rib disposed on a side of the cooling carrier seat, and the carrying portion being provided for installing the first substrate, and the supporting rib having an end fixed to the carrying portion and the other end fixed to an inner side of the cooling carrier seat;
installed in the cooling carrier seat, and the first substrate and the second substrate being perpendicular to each other and installed on both opposite sides of the carrying portion, and the second substrate being provided for carrying a driving circuit, and the driving circuit being electrically coupled to the LEDs and configured to be corresponsive to the notch to define an exposed status;
a lamp cap, coupled to the connecting portion;
a thermal glue, filled between the driving circuit and the lamp cap, and having a first conducting area and a second conducting area corresponsive to the driving circuit and the lamp cap respectively, wherein the first conducting area is attached to the driving circuit, and the second conducting area is attached to the lamp cap; and
a lamp cover, covered onto the base for sealing the first substrate and the LEDs therein.

12. The LED light bulb using a lamp cap for heat dissipation according to claim 11, wherein the second substrates are arranged opposite to each other, and the quantity and position of the notches are corresponsive to those of the second substrates, provided that there are two second substrates.

13. The LED light bulb using a lamp cap for heat dissipation according to claim 11, wherein the second substrates are arranged with an included angle equal to 60 degrees between any two adjacent second substrates, and the quantity and position of the notches are corresponsive to those of the second substrates, provided that there are three second substrates.

14. The LED light bulb using a lamp cap for heat dissipation according to claim 11, wherein the second substrates are arranged with an included angle equal to 360/n degrees between any two adjacent second substrates, and the quantity and position of the notches are corresponsive to those of the second substrates, provided that the quantity of second substrates is n, and n≧4.

15. The LED light bulb using a lamp cap for heat dissipation according to claim 11, wherein the base and the lamp cap are assembled by a rotational connection method, so that the thermal glue is coated onto the connecting portion.

16. The LED light bulb using a lamp cap for heat dissipation according to claim 12, wherein the base and the lamp cap are assembled by a rotational connection method, so that the thermal glue is coated onto the connecting portion.

17. The LED light bulb using a lamp cap for heat dissipation according to claim 13, wherein the base and the lamp cap are assembled by a rotational connection method, so that the thermal glue is coated onto the connecting portion.

18. The LED light bulb using a lamp cap for heat dissipation according to claim 14, wherein the base and the lamp cap are assembled by a rotational connection method, so method, so that the thermal glue is coated onto the connecting portion.

19. The LED light bulb using a lamp cap for heat dissipation according to claim 18, further comprising at least one electrical connector, installed on the first substrate, and the carrying portion having at least one opening corresponsive to the electrical connector, and a side of the electrical connector having a slot for mounting the second substrate, and electrically coupling the driving circuit with the LEDs.
